(19) United States
(12) Patent Application Publication
(10) Pub. No.: US 2024/0428221 A1
(43) Pub. Date: Dec. 26, 2024

(54) BUNDLED SPLITTING OF TRANSACTIONS

(71) Applicant: American Express Travel Related Services Company, Inc., New York, NY (US)

(72) Inventors: Meher Sahiti Kalvakuntla, Phoenix, AZ (US); Adam Krochak, New York, NY (US); Ian T. Moritz, Brooklyn, NY (US); Ian P. Pulice, Venice, CA (US); Mukund Shankar SimhaRaghu, Glendale, AZ (US); Vignesh Veeraiyan, Phoenix, AZ (US)

(21) Appl. No.: 18/337,951

(22) Filed: Jun. 20, 2023

(51) Int. Cl. G06Q 20/22; G06Q 20/10; G06Q 20/32

(52) U.S. Cl. CPC G06Q 20/29; G06Q 20/102; G06Q 20/3223

(57) ABSTRACT

Disclosed are various embodiments for bundling multiple transactions together to split among one or more individuals. A selection of a plurality of transactions presented through a user interface is obtained. Then, a split request is obtained through the user interface, the split request representing a request to split a total cost for the plurality of transactions with one or more individuals. Next, a selection of the one or more individuals is obtained, the selection comprising a respective personal identifier for each of the one or more individuals. Subsequently, a split message is sent to a transaction processing service, the split message comprising a plurality of transaction identifiers representing the plurality of transactions and the respective personal identifier for each of the one or more individuals.

### BACKGROUND

Many individuals use credit or debit cards to pay for transactions. However, payment terminals and other point-of-sale devices are often not configured to support split transactions, whereby a single purchase can be divided, split, or apportioned across multiple credit or debit cards. Accordingly, a single user may be forced to pay for the entire transaction using his or her credit card, even though a group of users intended to split the cost of the transaction amongst themselves.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a pictorial diagram of an example user interface rendered by a client according to various embodiments of the present disclosure.

FIG. 2 is a pictorial diagram of an example user interface rendered by a client according to various embodiments of the present disclosure.

FIG. 3A is a pictorial diagram of an example user interface rendered by a client according to various embodiments of the present disclosure.

FIG. 3B is a pictorial diagram of an example user interface rendered by a client according to various embodiments of the present disclosure.

FIG. 4 is a pictorial diagram of an example user interface rendered by a client according to various embodiments of the present disclosure.

FIG. 5 is a pictorial diagram of an example user interface rendered by a client according to various embodiments of the present disclosure.

FIG. 6 is a pictorial diagram of an example user interface rendered by a client according to various embodiments of the present disclosure.

FIG. 7 is a pictorial diagram of an example user interface rendered by a client according to various embodiments of the present disclosure.

FIG. 8 is a pictorial diagram of an example user interface rendered by a client according to various embodiments of the present disclosure.

FIG. 9 is a drawing of a network environment according to various embodiments of the present disclosure.

FIG. 10 is a sequence diagram depicting one example the interactions between the components of the network environment of FIG. 9 according to various embodiments of the present disclosure.

FIG. 11 is a sequence diagram depicting one example the interactions between the components of the network environment of FIG. 9 according to various embodiments of the present disclosure.

### DETAILED DESCRIPTION

Disclosed are various approaches for splitting multiple transactions made with a transaction account, such as charge card, credit card, or debit card, among multiple individuals. By allowing a user to bundle multiple transactions within a single request to apportion the costs of the transactions among one or more individuals, network bandwidth is preserved by reducing the number of requests, responses, or other messages sent across a network. Moreover, computational resources are conserved because a single request to split a group of transactions can be processed more efficiently than a series of requests to split the cost of individual transactions. As a result, the various embodiments of the present disclosure improve the operation of various computing and networking devices that might be involved.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

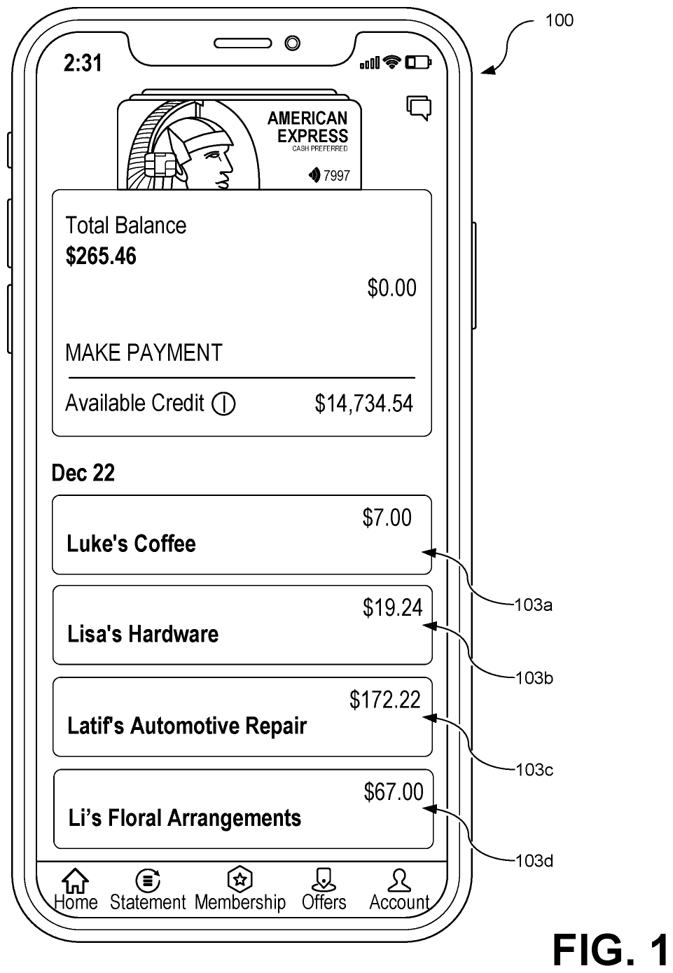

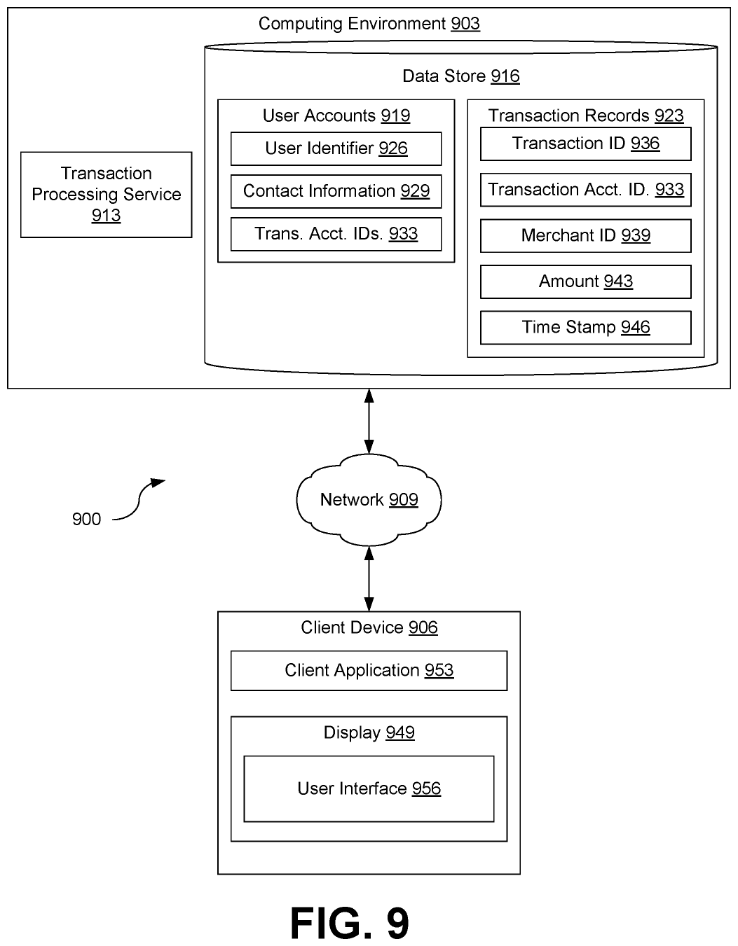

FIG. 1 depicts a user interface 956 (FIG. 9) of a client application 953 (FIG. 9) presented by a client device 100 according to various embodiments of the present disclosure. The user interface 956 can show information related to a transaction account of a user. This can include information such as a total balance associated with the transaction account and a list of one or more transactions that the user has made with his or her transaction account. Information about individual transactions can be presented, such as the date of the transaction, the amount of the transaction, and the counterparty for the transaction (e.g., the merchant, service provider, etc.). A user can interact with a user interface element 103 (e.g., user interface element 103a, 103b, 103c, or 103d) in order to view or obtain more information about an individual transaction.

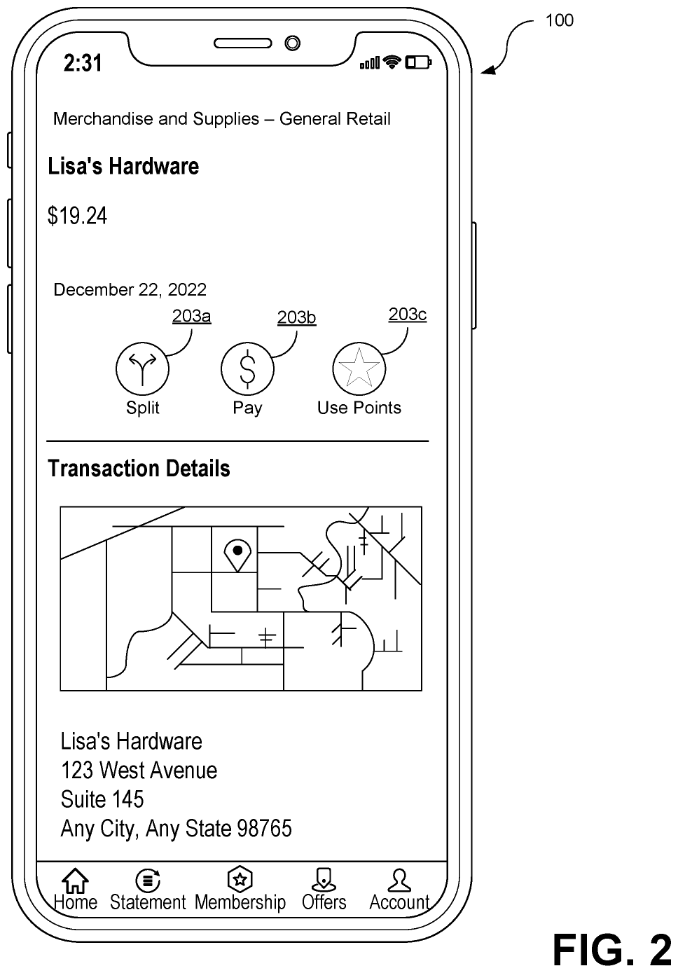

FIG. 2 depicts a user interface 956 (FIG. 9) of a client application 953 (FIG. 9) presented by a client device 100 according to various embodiments of the present disclosure. A user could reach the user interface 956 depicted in FIG. 2 by interacting with a user interface element 103 to view more information about a transaction (e.g., user interface element 103b). The user interface 956 could present information to a user, such as the type of the transaction or type of merchant as identified by a merchant category code, the amount of the transaction, the date of the transaction, and the location of the transaction (e.g., the location of the merchant). In addition, the user interface 956 could provide one or more user interface elements 203 (e.g., user interface element 203a, 203b, and 203c) to allow a user to perform various actions related to the transaction. For example, a user could interact with user interface element 203a to split the cost of the transaction with one or more individuals, while the user could interact with user interface element 203b to pay for the transaction (e.g., by transferring funds from checking or savings account) or interact with user interface element 203c to redeem rewards points to pay for the transaction.

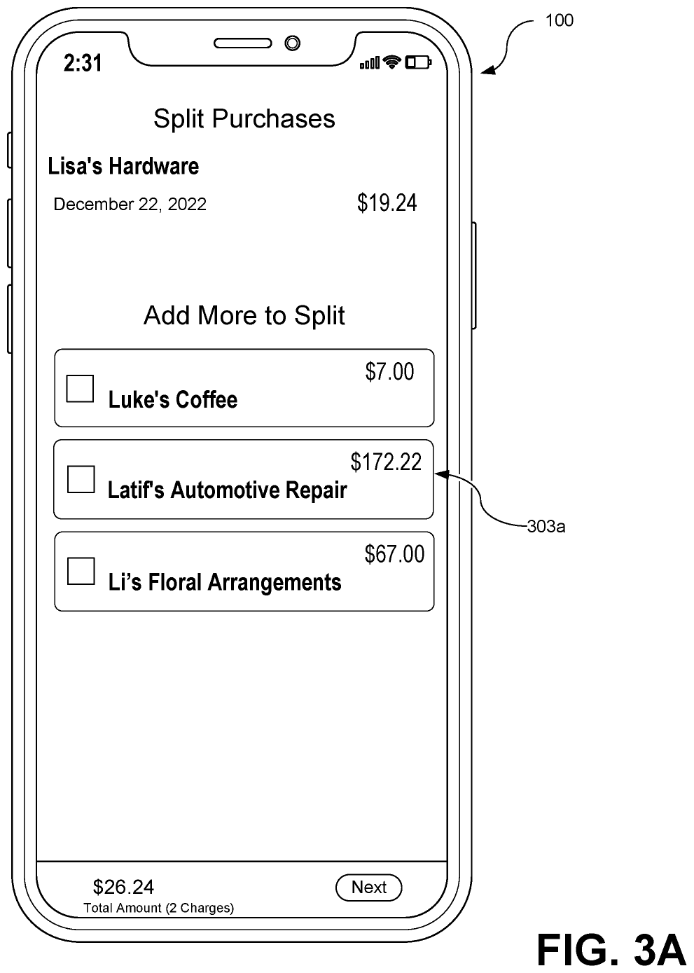

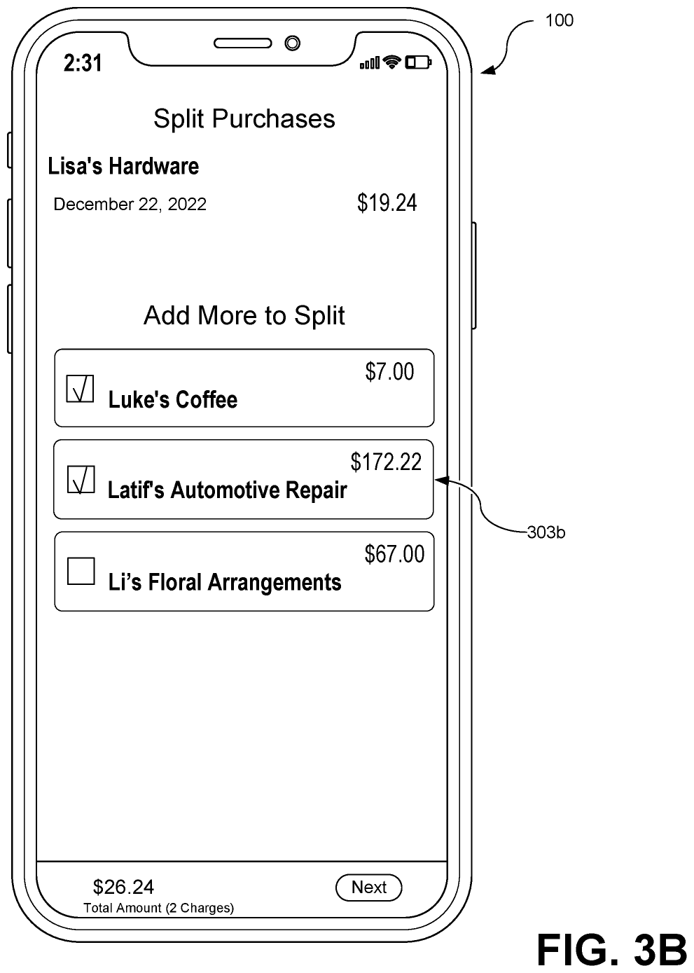

FIG. 3A depicts a user interface 956 (FIG. 9) of a client application 953 (FIG. 9) presented by a client device 100 according to various embodiments of the present disclosure. A user could reach the user interface 956 depicted in FIG. 3A by interacting with user interface element 203a to split the cost of a transaction with one or more additional individuals. In response, the user could be presented with the user interface 956 of FIG. 3A, which could show the transaction to be split, as well as a transaction list 303a that identifies additional transactions that the user could select to include in the split. The user could then select one or more of the transactions included in the transaction list 303a to split.

FIG. 3B depicts a user interface 956 (FIG. 9) of a client application 953 (FIG. 9) presented by a client device 100 according to various embodiments of the present disclosure. A user could reach the user interface 956 depicted in FIG. 3B by interacting with user interface element 203a to split the cost of a transaction with one or more additional individuals. In response, the user could be presented with the user interface 956 of FIG. 3B, which could show the transaction to be split, as well as a transaction list 303a that identifies additional transactions that the user could select to include in the split. However, unlike the user interface 956 of FIG. 3A, the user interface 956 of FIG. 3B can have one or more transactions in the transaction list 303a preselected for the user.

Transactions could be preselected for the user in a number of situations. For example, the issuer of the transaction account could use various machine learning approaches to determine that certain transactions, or types of transactions, are often bundled together when splitting the cost. As another example, the user of could have instructed the issuer of the transaction account to bundle charges that met specified criteria (e.g., all charges occurring within a specified time range). Although the transactions in the transaction list 303b may be preselected for the user, the user could include or exclude individual transactions as well.

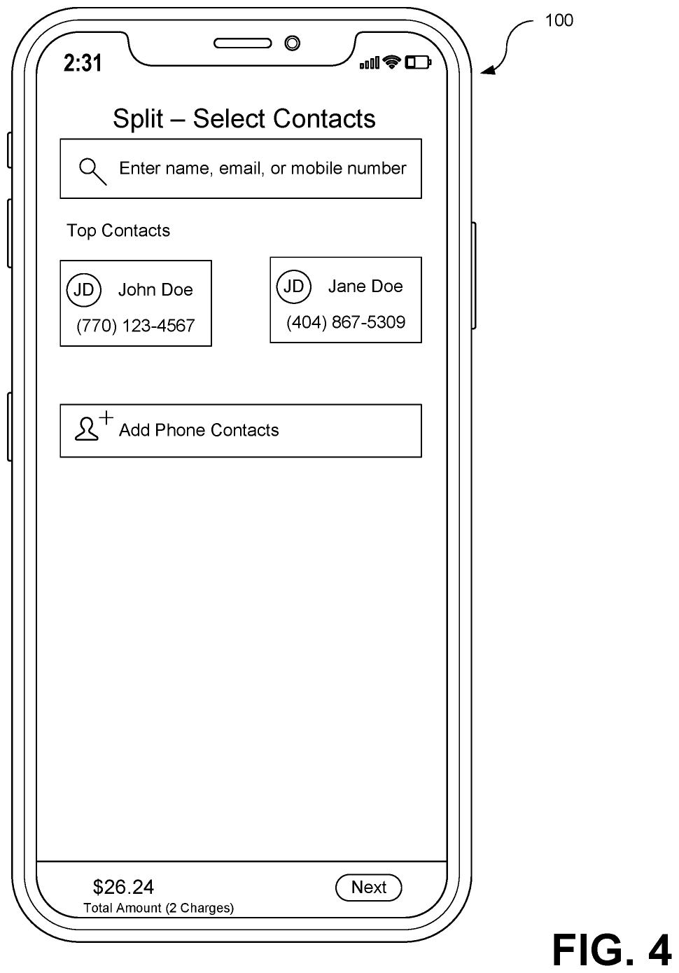

FIG. 4 depicts a user interface 956 (FIG. 9) of a client application 953 (FIG. 9) presented by a client device 100 according to various embodiments of the present disclosure. In FIG. 4, a user can search for add individuals to a list, group, or set of individuals with whom the user wishes to split the cost for the transactions selected in FIG. 3A or FIG. 3B. The user can, for example, search for individuals based on contacts in his or her client device. The user can also, for example, search for other individuals registered to split transactions (e.g., by name, email, or phone number). The user could also select individuals with whom the user has previously split the cost of a transaction.

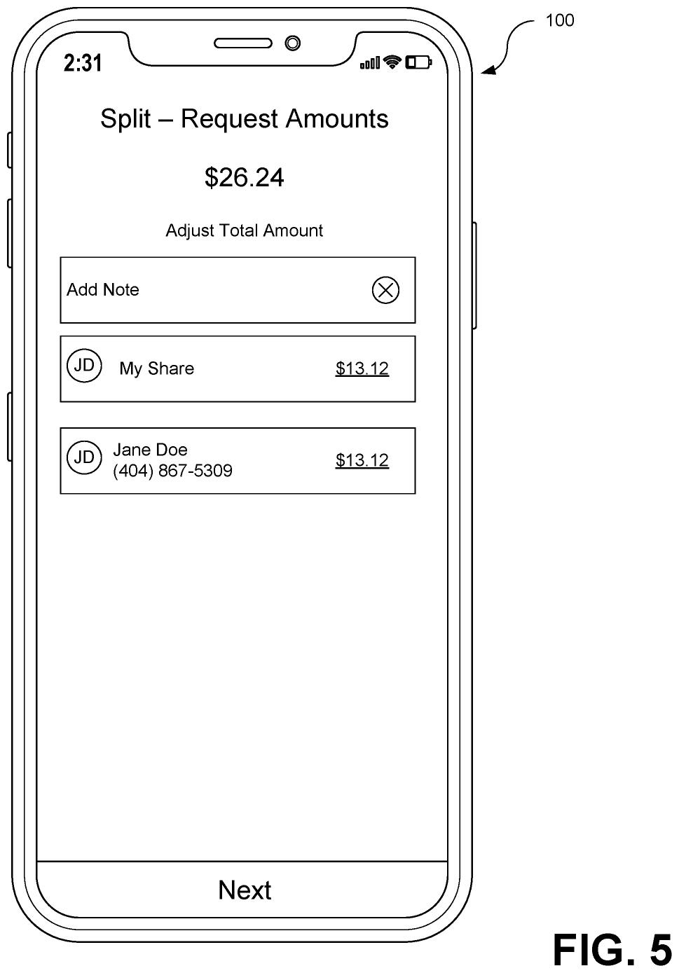

FIG. 5 depicts a user interface 956 (FIG. 9) of a client application 953 (FIG. 9) presented by a client device 100 according to various embodiments of the present disclosure. A user can reach the user interface 956 of FIG. 5 after having selected one or more individuals, using the user interface 956 of FIG. 4, with whom to split the selected transactions. Within the user interface 956 of FIG. 5, the user could choose how to apportion responsibility for the selected transactions. For example, the user could be presented with a default split that is equitably divided. The user could then adjust or alter the apportionment of the split (e.g., where one person agreed to pay for a larger portion). A user could also add a note describing the transactions or set of transactions to be split with the selected individuals.

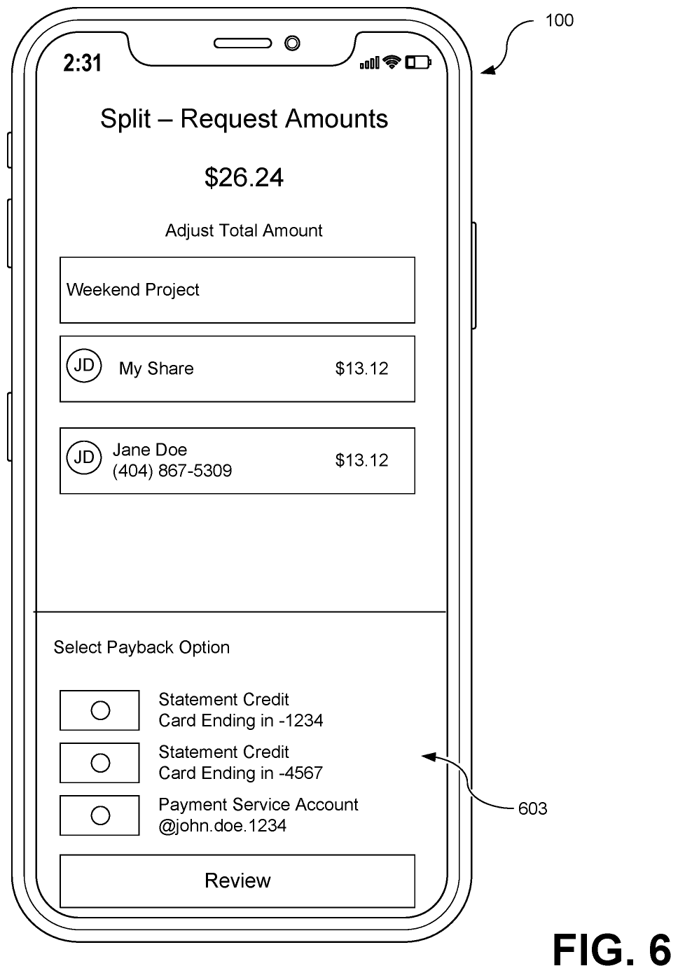

FIG. 6 depicts a user interface 956 (FIG. 9) of a client application 953 (FIG. 9) presented by a client device 100 according to various embodiments of the present disclosure. A user can reach the user interface 956 of FIG. 6 after having confirmed the apportioned amounts of the split within the user interface 956 of FIG. 5. Accordingly, the user interface 956 of FIG. 6 can list the selected individuals with whom the transaction will be split, the amounts apportioned to the selected individuals, any note or description entered by the user at FIG. 5, etc. The user interface 956 of FIG. 6 can also display a transaction account list 603 that identifies transaction accounts registered to, owned by, or associated with the user. The user can select a transaction account from the transaction account list 603, which would be used to receive deposits of funds from the selected individuals. Once a transaction account is selected form the transaction account list 603, the user can then continue to review and confirm the split.

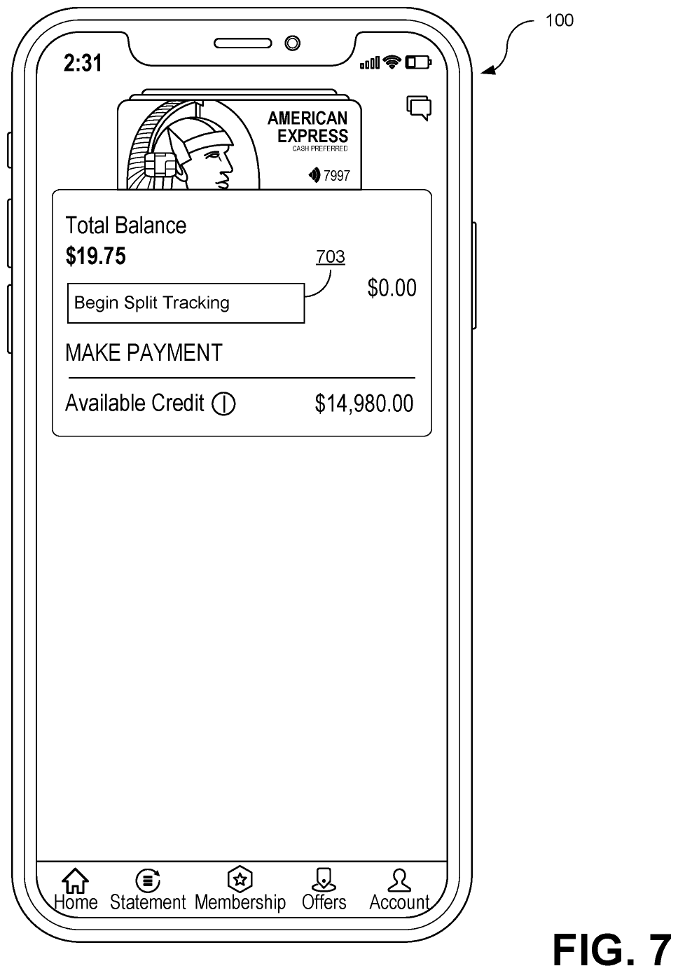

FIG. 7 depicts a user interface 956 (FIG. 9) of a client application 953 (FIG. 9) presented by a client device 100 according to various embodiments of the present disclosure. As previously discussed with respect to FIG. 3B, transactions could be preselected as suggested transactions to include in a bundle of transactions to split. A user could use the user interface 956 of FIG. 7 to assist the issuer in identifying potential transactions to preselect.

As shown, FIG. 7 includes a user interface element 703, which can be used to begin split tracking. In some embodiments, this could cause the client application 953 to preselect any transactions that occurred after the user initiated split tracking.

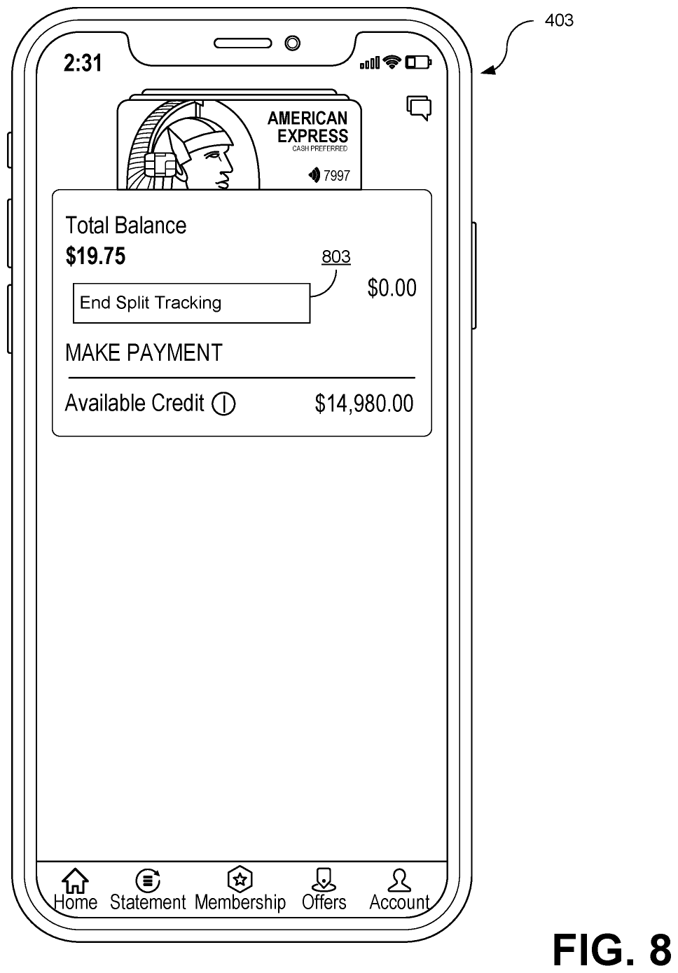

FIG. 8 depicts a user interface 956 (FIG. 9) of a client application 953 (FIG. 9) presented by a client device 100 according to various embodiments of the present disclosure. After a user has initiated split tracking with the user interface 956 of FIG. 7, a user could interact with the user interface element 803 to terminate or cease split tracking. This could cause the client application 953 to exclude any transactions that were subsequently initiated from a preselected list of transactions, such as those depicted in FIG. 3B.

With reference to FIG. 9, shown is a network environment 900 according to various embodiments. The network environment 900 can include a computing environment 903 and a client device 906, which can be in data communication with each other via a network 909.

The network 909 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 909 can also include a combination of two or more networks 909. Examples of networks 909 can include the Internet, intranets, extranets, virtual private networks (VPNs), and similar networks.

The computing environment 903 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 903 can employ a plurality of computing devices that can be arranged in one or more server banks or computer banks or other arrangements. Such computing devices can be located in a single installation or can be distributed among many different geographical locations. For example, the computing environment 903 can include a plurality of computing devices that together can include a hosted computing resource, a grid computing resource or any other distributed computing arrangement. In some cases, the computing environment 903 can correspond to an elastic computing resource where the allotted capacity of processing, network, storage, or other computing-related resources can vary over time.

Various applications or other functionality can be executed in the computing environment 903. The components executed on the computing environment 903 include a transaction processing service 913, and other applications, services, processes, systems, engines, or functionality not discussed in detail herein.

Also, various data is stored in a data store 916 that is accessible to the computing environment 903. The data store 916 can be representative of a plurality of data stores 916, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 916 is associated with the operation of the various applications or functional entities described below. This data can include one or more user accounts 919, one or more transaction records 923, and potentially other data.

A user account 919 can represent information related to a user who has at least one transaction account (e.g., credit or charge card account, demand deposit account, stored value payment account, etc.) maintained by the issuer who operates the transaction processing service 913. Accordingly, each user account 919 can include information such as a user identifier 926, contact information 929, and one or more transaction account identifiers 933. The user identifier 926 for a user account 919 can represent any identifier that uniquely identifies one user account 919 with respect to another user account 919. The contact information 929 can represent identifiers that can be used to send information to the user, such as telephone numbers (e.g., cellular phone numbers), email addresses, mailing addresses, etc. The transaction account identifiers 933 can represent identifiers that uniquely identify one transaction account with respect to another transaction account. The transaction account identifiers 933 stored in association with a user account 919 can represent those transaction accounts that a user owns, controls, or is an authorized user.

A transaction record 923 can represent any transaction made with a transaction account (e.g., credit or charge card account, demand deposit account, stored value payment account, etc.). Accordingly, each transaction record 923 can include information such as a transaction identifier 936, a transaction account identifier 933 of the transaction account that was used for the transaction, a merchant identifier 939 for the merchant with whom the transaction was made, the amount 943 of the transaction, and the time stamp 946 of the transaction. The transaction identifier 936 can represent any identifier that uniquely identifies one transaction with respect to another and, therefore, one transaction record 923 with respect to another. The amount 943 can represent the amount of currency or currency equivalent (e.g., rewards points), or combination thereof, used to pay for or fund the transaction. The time stamp 946 can represent the date and/or time at which the transaction was authorized or that a request to authorize the transaction was made, depending on the implementation.

The transaction processing service 913 can be executed to process requests to split the total amount 943 of one or more transactions between one or more individuals. The transaction processing service 913 can be operated by an issuer of a transaction account (e.g., credit or charge card account, demand deposit account, stored value payment account, etc.). Among the features provided by the transaction processing service 913 include the ability to receive requests to split transactions, request funds from the specified individuals, and/or coordinate the receipt of funds to a specified transaction account. Other features may also be provided in various implementations. For example, the transaction processing service 913 could be respond to requests for information or data from the client application 953 executing on the client device 906.

The client device 909 is representative of a plurality of client devices that can be coupled to the network 909. The client device 909 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 909 can include one or more displays 949, such as liquid crystal displays (LCDs), gas plasma-based flat panel displays, organic light emitting diode (OLED) displays, electrophoretic ink (“E-ink”) displays, projectors, or other types of display devices. In some instances, the display 949 can be a component of the client device 909 or can be connected to the client device 909 through a wired or wireless connection.

The client device 909 can be configured to execute various applications such as a client application 953 or other applications. The client application 953 can be executed in a client device 909 to access network content served up by the computing environment 903 or other servers, thereby rendering a user interface 956 on the display 949. To this end, the client application 953 can include a browser, a dedicated application, or other executable, and the user interface 956 can include a network page, an application screen, or other user mechanism for obtaining user input. The client device 909 can be configured to execute applications beyond the client application 953 such as email applications, social networking applications, word processors, spreadsheets, or other applications.

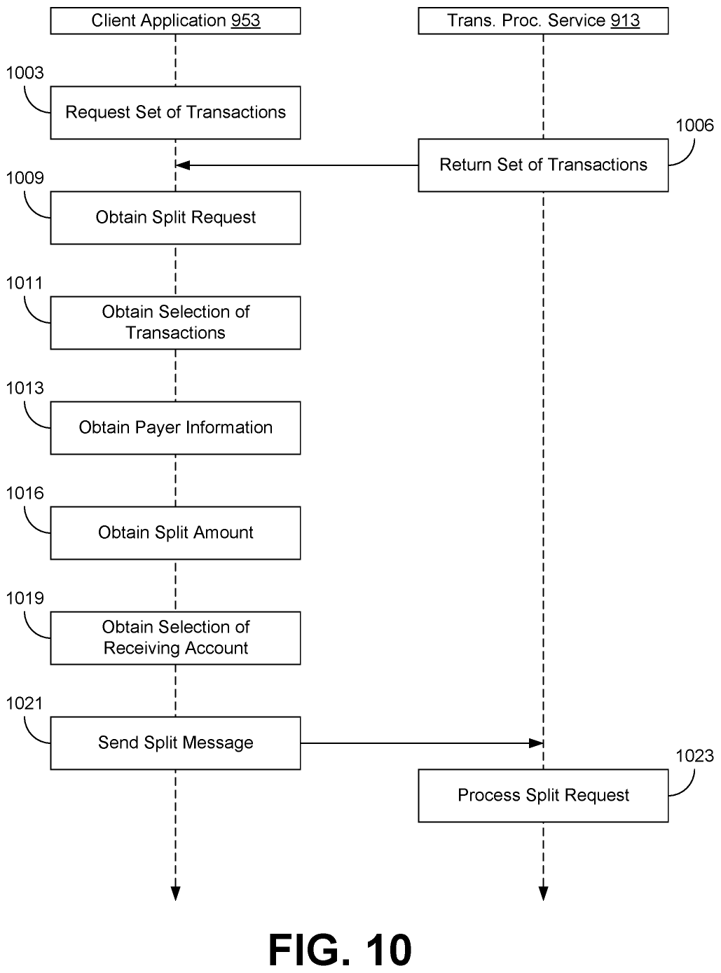

Referring next to FIG. 10, shown is a sequence diagram that provides one example of the operation of the interactions between the client application 953 and the transaction processing service 913. The sequence diagram of FIG. 10 provides merely an example of the many different types of functional arrangements that can be employed to implement the operations of the depicted portions of the client application 953 and the transaction processing service 913. As an alternative, the sequence diagram of FIG. 10 can be viewed as depicting an example of elements of a method implemented within the network environment 900.

Beginning with block 1003, the client application 953 can request a set of transactions from the transaction processing service 913. Various criteria or delimiters could be included in the request, such as date ranges, the user identifier 926 for the user of the client application 953, the transaction account identifier 933 for a transaction account of the user, etc. This could be done, for example, in order to show or present one or more transactions within the user interface 956, such as the user interface 956 depicted in FIG. 1.

In response to the request, the transaction processing service 913 can return one or more transactions or transaction records 923 to the client application 953. For example, the transaction processing service 913 could search the transaction records 923 that satisfy the query or request transaction records 923 that match the parameters or delimiters specified in the request sent at block 1003. For example, the transaction processing service 913 could verify that the transaction account identifier 933 provided by the client application 953 matches a transaction account identifier 933 linked to the user account 919 identified by the user identifier 926. The transaction processing service 913 could then retrieve all of the transaction records 923 that match the transaction identifier 936 supplied by the client application 953 which fall within the specified date range (e.g., the last day, last week, the last billing cycle, the current billing cycle, etc.). The transactions processing service 913 could then return the transaction records 923 that were identified or, could return a portion of the data stored in each matching transaction record 923 that would represent the transactions.

Later, at block 1009, the client application 953 can obtain a split request indicating that the user desires to split or apportion the cost of a transaction with one or more individuals. The split request could be obtained, for example, through a user interaction with the user interface element 203a depicted in FIG. 2. However, other user interactions could also indicate an intent to split the transaction to the client application 953.

Moving on to block 1011, the client application 953 can obtain a selection of one or more additional transactions to split between the one or more individuals. For example, in response to the split request, the client application 953 could provide a list of additional transactions for the user to select as illustrated in FIG. 3A or FIG. 3B.

Next, at block 1013, the client application 953 could obtain information or a selection of the individual payers who will split the cost of the transactions selected at block 1011. For example, the client application 953 could present a user interface 956 to the user, such as the user interface 956 depicted in FIG. 4. A user could use the user interface to select one or more recipients. For example, the user could select one or more individuals from his or her locally stored contacts. In response, the client application 953 could access the stored contacts on the client device 906 an present them to the user for selection. As another example, the client application 953 could store the set of previously or most frequently selected individuals and present them as options that could be selected by the user. In some implementations, the client application 953 could obtain contact information 929 (e.g., email address, mobile phone, etc.) to use as a search query. The client application 953 could then send a search request to the transaction processing service 913 for user accounts 919 with matching contact information 929. If a matching user account 919 is identified, then the user's information (e.g., name, contact information 929, etc.) could be returned by the transaction processing service 913 for selection as one of the payers.

Then, at block 1016, the client application 953 could obtain a split amount, ratio, or other apportionment of the cost of the transactions selected at block 1011 among the individuals selected at block 1013. This could be done, for example, using a user interface 956 such as the user interface 956 depicted in FIG. 5. In some implementations, the client application 953 could present an equitable split where the costs are split evenly amount the selected individuals. The user could then adjust the apportionments to the selected individuals or proceed with the split process.

Subsequently, at block 1019, the client application 953 could send obtain a selection of a receiving or recipient. This would be the transaction account that would receive funds, or credit for funds, paid by the individuals selected at block 1013. For example, the client application 953 could present a list of transaction accounts associated with the user of the client application 953. The user could then select one of the presented transaction accounts using a user interface 956, such as the user interface 956 depicted in FIG. 6. To determine which transaction accounts to present to the user within the user interface 956, the client application 953 could, for example, request a list of transaction account identifiers 933 associated with the user account 919 of the user of the client application 953. The client application 953 could then present information about the identified transaction accounts within the user interface 956.

Proceeding to block 1021, the client application 953 could then send a split message or split request to the transaction processing service 913. The split request could include a list of transaction identifiers 936 for the transactions that would be split, a list of the payers selected to repay the user, the apportioned amounts to the selected users, and the receiving or recipient transaction account.

In response, at block 1023, the transaction processing service 913 can process the split request. For example, the transaction processing service 913 could send a request for funds to each selected individual. The request for funds could include information such as the selected transactions, the amount apportioned to the user, the identity of the requesting party, etc. The transaction processing service 913 could also account for the funds received from the requested individuals and credit the selected recipient or receiving account appropriately.

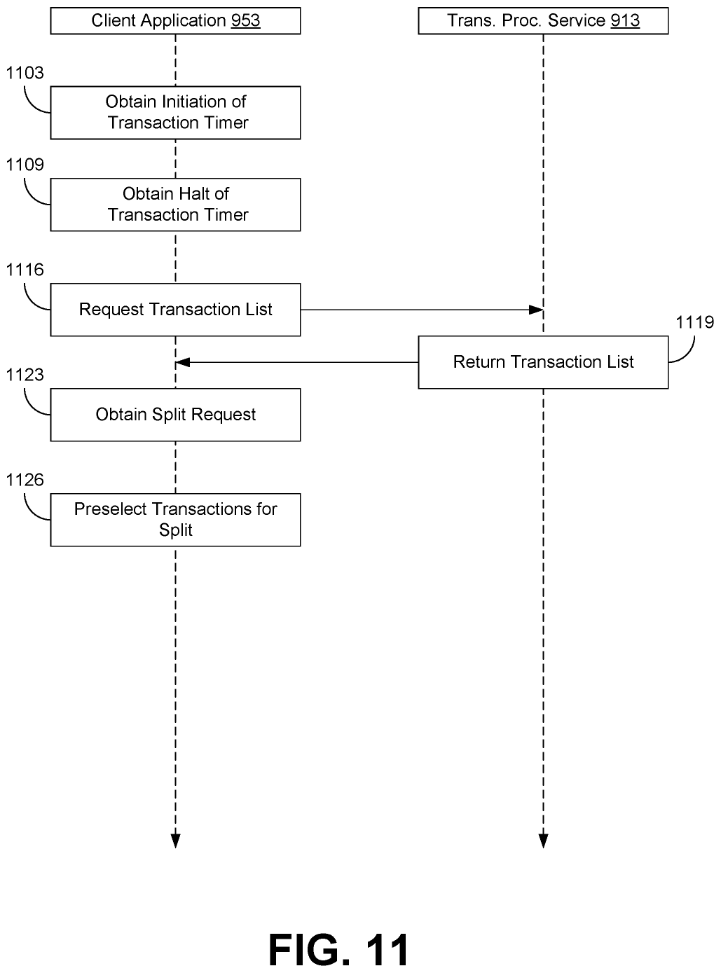

Referring next to FIG. 11, shown is a sequence diagram that provides one example of the operation of the interactions between the client application 953 and the transaction processing service 913. The sequence diagram of FIG. 11 provides merely an example of the many different types of functional arrangements that can be employed to implement the operations of the depicted portions of the client application 953 and the transaction processing service 913. As an alternative, the sequence diagram of FIG. 11 can be viewed as depicting an example of elements of a method implemented within the network environment 900.

Beginning with block 1103, the client application 953 can obtain an initiation of a transaction timer. This could be done, for example, through the user interface 956 depicted in FIG. 7. Once the transaction timer is initiated, the client application 953 could store the time at which the transaction timer was started (e.g., date and time, timestamp, etc.).

Next, at block 1109, the client application 953 can obtain a halt, end or completion of the transaction timer. This could be done, for example, through the user interface 956 depicted in FIG. 8. Once the transaction timer is halted, the client application 953 could store the time at which the transaction timer was halted (e.g., date and time, timestamp, etc.).

Proceeding to block 1116, the client application 953 can request a set of transactions from the transaction processing service 913. Various criteria or delimiters could be included in the request, such as date ranges, the user identifier 926 for the user of the client application 953, the transaction account identifier 933 for a transaction account of the user, etc. This could be done, for example, in order to show or present one or more transactions within the user interface 956, such as the user interface 956 depicted in FIG. 1.

In response, at block 1119, the transaction processing service 913 can return one or more transactions or transaction records 923 to the client application 953. For example, the transaction processing service 913 could search the transaction records 923 that satisfy the query or request transaction records 923 that match the parameters or delimiters specified in the request sent at block 1003. For example, the transaction processing service 913 could verify that the transaction account identifier 933 provided by the client application 953 matches a transaction account identifier 933 linked to the user account 919 identified by the user identifier 926. The transaction processing service 913 could then retrieve all of the transaction records 923 that match the transaction identifier 936 supplied by the client application 953 which fall within the specified date range (e.g., the last day, last week, the last billing cycle, the current billing cycle, etc.). The transactions processing service 913 could then return the transaction records 923 that were identified or, could return a portion of the data stored in each matching transaction record 923 that would represent the transactions.

Subsequently, at block 1123, the client application 953 can obtain a split request indicating that the user desires to split or apportion the cost of a transaction with one or more individuals. The split request could be obtained, for example, through a user interaction with the user interface element 203a depicted in FIG. 2. However, other user interactions could also indicate an intent to split the transaction to the client application 953.

Then, at block 1126, the client application 953 could preselect one or more transactions that were returned at block 1119. For example, the client application 953 could evaluate the time stamp 949 associated with each transaction to determine whether the transaction occurred between the time that the transaction timer was started and the time that the transaction timer was halted. Any transactions with a time stamp 949 that occurred within that period of time could be preselected. The preselected transactions could then be presented to the user for his or her confirmation or modification (e.g., within the user interface depicted in FIG. 3B).

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 903.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a client computing device comprising a processor and a memory; and
machine-readable instructions stored in the memory that, when executed by the processor, cause the client computing device to at least:
obtain a selection of a plurality of transactions presented through a user interface;
obtain a split request through the user interface, the split request representing a request to split a total cost for the plurality of transactions with one or more individuals;
obtain a selection of the one or more individuals, the selection comprising a respective personal identifier for each of the one or more individuals; and
send a split message to a transaction processing service, the split message comprising a plurality of transaction identifiers representing the plurality of transactions and the respective personal identifier for each of the one or more individuals.

2. The system of claim 1, wherein the machine-readable instructions further cause the computing device to at least:
identify, within the user interface, the plurality of transactions as a suggested set of transactions to include in the split request.

3. The system of claim 1, wherein the machine-readable instructions further cause the computing device to at least:
present, within the user interface, a transaction timer;
in response to a first interaction with the transaction timer, store a start time for the transaction timer;
in response to a second interaction with the transaction timer, store an end time for the transaction timer; and
present, within the user interface, a preselection of the plurality of transactions, wherein the plurality of transactions occurred between the start time and the end time.

4. The system of claim 1, wherein the machine-readable instructions further cause the computing device to at least:
obtain, through the user interface, a split amount for the one or more individuals; and
wherein the split message further includes the split amount.

5. The system of claim 4, wherein the split amount specifies an equitable split of the total cost for the plurality of transactions.

6. The system of claim 4, wherein the split amount specifies a user defined portion of the total cost for the plurality of transactions for each of the one or more individuals.

7. The system of claim 1, wherein the machine-readable instructions further cause the computing device to at least:
receive, from the transaction processing service, a recommended set of transactions to split, wherein the plurality of transactions are included in the recommended set of transactions; and
present, within the user interface, the recommended set of transactions to split as a preselected set of transactions to split.

8. A method, comprising:
obtaining a selection of a plurality of transactions presented through a user interface;
obtaining a split request through the user interface, the split request representing a request to split a total cost for the plurality of transactions with one or more individuals;
obtaining a selection of the one or more individuals, the selection comprising a respective personal identifier for each of the one or more individuals; and
sending a split message to a transaction processing service, the split message comprising a plurality of transaction identifiers representing the plurality of transactions and the respective personal identifier for each of the one or more individuals.

9. The method of claim 8, further comprising identifying, within the user interface, the plurality of transactions as a suggested set of transactions to include in the split request.

10. The method of claim 8, further comprising:
presenting, within the user interface, a transaction timer;
in response to a first interaction with the transaction timer, storing a start time for the transaction timer;
in response to a second interaction with the transaction timer, storing an end time for the transaction timer; and
presenting, within the user interface, a preselection of the plurality of transactions, wherein the plurality of transactions occurred between the start time and the end time.

11. The method of claim 8, further comprising:
obtaining, through the user interface, a split amount for the one or more individuals; and
wherein the split message further includes the split amount.

12. The method of claim 11, wherein the split amount specifies an equitable split of the total cost for the plurality of transactions.

13. The method of claim 11, wherein the split amount specifies a user defined portion of the total cost for the plurality of transactions for each of the one or more individuals.

14. The method of claim 8, further comprising:
receiving, from the transaction processing service, a recommended set of transactions to split, wherein the plurality of transactions are included in the recommended set of transactions; and
presenting, within the user interface, the recommended set of transactions to split as a preselected set of transactions to split.

15. A non-transitory, computer-readable medium, comprising machine-readable instructions that, when executed by a processor of a computing device, cause the computing device to at least:
obtain a selection of a plurality of transactions presented through a user interface;
obtain a split request through the user interface, the split request representing a request to split a total cost for the plurality of transactions with one or more individuals;
obtain a selection of the one or more individuals, the selection comprising a respective personal identifier for each of the one or more individuals; and
send a split message to a transaction processing service, the split message comprising a plurality of transaction identifiers representing the plurality of transactions and the respective personal identifier for each of the one or more individuals.

16. The non-transitory, computer-readable medium of claim 15, wherein the machine-readable instructions further cause the computing device to at least:
identify, within the user interface, the plurality of transactions as a suggested set of transactions to include in the split request.

17. The non-transitory, computer-readable medium of claim 15, wherein the machine-readable instructions further cause the computing device to at least:
present, within the user interface, a transaction timer;
in response to a first interaction with the transaction timer, store a start time for the transaction timer;
in response to a second interaction with the transaction timer, store an end time for the transaction timer; and
present, within the user interface, a preselection of the plurality of transactions, wherein the plurality of transactions occurred between the start time and the end time.

18. The non-transitory, computer-readable medium of claim 15, wherein the machine-readable instructions further cause the computing device to at least:
obtain, through the user interface, a split amount for the one or more individuals; and
wherein the split message further includes the split amount.

19. The non-transitory, computer-readable medium of claim 18, wherein the split amount specifies a user defined portion of the total cost for the plurality of transactions for each of the one or more individuals.

20. The non-transitory, computer-readable medium of claim 15, wherein the machine-readable instructions further cause the computing device to at least:
receive, from the transaction processing service, a recommended set of transactions to split, wherein the plurality of transactions are included in the recommended set of transactions; and
present, within the user interface, the recommended set of transactions to split as a preselected set of transactions to split.
